(19) United States
(12) Patent Application Publication
(10) Pub. No.: US 2013/0187515 A1
(43) Pub. Date: Jul. 25, 2013

(54) Vehicular Alternating Current Generator

(71) Applicants: Kenji Miyata, Hitachinaka (JP); Takayuki Koyama, Hitachi (JP); Maki Ishikawa, Hadano (JP)

(72) Inventors: Yoshihisa Ishikawa, Hadano (JP); Kenji Miyata, Hitachinaka (JP); Takayuki Koyama, Hitachi (JP)

(73) Assignee: Hitachi Ltd., Chiyoda-ku, Tokyo (JP)

(21) Appl. No.: 13/575,361

(22) PCT Filed: Mar. 31, 2010
(86) PCT No.: PCT/JP2010/055899

§ 371 Date: Feb. 5, 2013

(51) Int. Cl. H02K 1/24

(52) U.S. Cl. CPC H02K 1/243
USPC 310/263

(57) ABSTRACT

A vehicular alternating current generator includes a Lundell rotor and a stator. The Lundell rotor includes a cylindrical portion around which a field coil is wound; plate-shaped first and second end plate portions disposed on both end faces in an axial direction of the cylindrical portion so as to face each other; a plurality of first claw portions extending in parallel with a rotational axis in a direction from the first end plate portion to the second end plate portion; and second claw portions extending in parallel with the rotational axis in a direction from the second end plate portion to the first end plate portion, the second claw portions being disposed circumferentially and alternately relative to the first claw portions. The stator is disposed on an outer periphery of the rotor so as to face the rotor with a small rotational air gap there between.

### TECHNICAL FIELD

The present invention relates to a vehicular alternating current generator mounted on, for example, a passenger vehicle and a truck.

### BACKGROUND ART

Automotive alternating current generators are lately required to achieve reduction in size and improved power generating capacity from a body that is the same in size as the conventional ones. Specifically, what is required is to provide a compact vehicular alternating current generator that can produce a high power output at a reasonable price.

The vehicular alternating current generator disclosed in Patent Document 1 includes a rotor that has a Lundell core including a cylindrical portion, a yoke portion, and a claw-shaped magnetic pole portion. Let AT be a magnetomotive force of a field coil and Rm be a sum of magnetic resistance of different parts (the cylindrical portion, the yoke portion, the claw-shaped magnetic pole portion, an air gap, a stator core). Then, magnetic flux Φ generated from the rotor can be given by an expression Φ=AT/Rm as is well known. Referring to FIG. 2 of Patent Document 1, the magnetic flux Φ flows from the cylindrical portion to the yoke portion and the claw-shaped magnetic pole portion, and to the stator core.

According to Patent Document 1, conventionally, it is preferable that each of different portions (the cylindrical portion, the yoke portion, and the claw-shaped magnetic pole portion) of the Lundell core have a substantially identical magnetic path cross-sectional area. In addition, a space should also be allotted for winding the field coil. The magnetic path cross-sectional area of the stator core is determined in accordance with the magnetic flux generated by the rotor designed as described above. Generally speaking, the material for the stator core has a magnetic characteristic better than that of the material for the rotor core. The magnetic path cross-sectional area of the stator core is therefore set to be smaller than that of the rotor core.

An approach different from such a conventional design method is taken and arrangements are proposed in which the stator core has an axial length longer than that of the rotor cylindrical portion and the cross-sectional area at the root of the claw-shaped magnetic pole portion is made narrower than the area of the cylindrical portion or the cross-sectional area of the yoke portion (see, for example, Patent Documents 1 and 2). In these arrangements, part of the magnetic flux is made to flow from the yoke portion directly into the stator core and the cross-sectional area at the root of the claw-shaped magnetic pole portion is made small to thereby achieve a coil cross section of the field coil.

### PRIOR ART DOCUMENTS

### Patent Documents

### Patent Document 1:

Japanese Patent No. 3381608

### Patent Document 2:

Japanese Patent No. 3436148

### SUMMARY OF THE INVENTION

### Problem to be Solved by the Invention

However, in a case of the arrangement for having the cross-sectional area at the root of the claw-shaped magnetic pole portion narrower than the area of the cylindrical portion or the cross-sectional area of the yoke portion, as in the rotor core disclosed in Patent Document 1 described above, it is required to conduct an even more detailed examination in consideration of magnetic saturation near the root of the claw-shaped magnetic pole portion. For example, if the cross-sectional area at the root of the claw-shaped magnetic pole portion is made too small, magnetic resistance increases to be saturated at the root of the claw-shaped magnetic pole portion, which hampers intended improvement in the output current. As such, a need exists in the vehicular alternating current generator for finding how to improve the output current.

### Means for Solving the Problem

To solve the foregoing problem, one preferred aspect of the present invention is as follows.

Specifically, a vehicular alternating current generator comprises a Lundell rotor and a stator. The Lundell rotor includes: a cylindrical portion around which a field coil is wound; plate-shaped first and second end plate portions disposed on both end faces in an axial direction of the cylindrical portion so as to face each other; a plurality of first claw portions extending in parallel with a rotational axis in a direction from the first end plate portion to the second end plate portion; and second claw portions extending in parallel with the rotational axis in a direction from the second end plate portion to the first end plate portion, the second claw portions being disposed circumferentially and alternately relative to the first claw portions. The stator is disposed on an outer periphery of the Lundell rotor so as to face the Lundell rotor with a small rotational air gap therebetween, the stator having a laminated core around which an armature coil is wound. Each of the first and second end plate portions includes a disk zone that is continuous around an entire circumference of the rotational axis and a plurality of protruding zones protruding in an outer peripheral direction from the disk zone thereby to form the claw portions. A bottom portion of a trough zone formed between adjacent protruding zones is set to have a diameter dimension that falls between 68 mm and 78 mm both inclusive.

### Effect of the Invention

The present invention allows an output and efficiency of the vehicular alternating current generator to be further improved and the output and efficiency to be maximized.

### BRIEF DESCRIPTION OF THE DRAWINGS

FIG. 1 is a cross-sectional view showing arrangements of a vehicular alternating current generator 100.

FIG. 2 is a partial cross-sectional view showing a rotor.

FIG. 3 is an illustration showing a stator core 21, and rotor cores 112F, 112R.

FIG. 4 is an illustration showing the rotor core 112F as viewed from an axial direction.

FIG. 5 is an illustration showing a back surface side of the rotor core.

FIG. 6 is an illustration showing an arrangement of a rectifying circuit that performs three-phase full-wave rectification.

FIG. 7 shows illustrations illustrating an equivalent magnetic circuit.

FIG. 8 shows illustrations showing details of an end plate portion 112b.

FIG. 9 is a graph showing results of simulation of an output (A/kg) relating to a φ128 alternator.

FIG. 10 is a graph showing results of simulation of an output (A/kg) relating to a φ139 alternator.

FIG. 11 is an illustration showing a rotor core when a trough diameter De of a trough zone is smaller than a root inside diameter Dc of a claw portion 112c.

FIG. 12 is a graph showing calculations for the φ128 alternator.

FIG. 13 is a graph showing a relationship between De and an output current when X1/X2=1.1 and Ls/Ly=1.3 in the φ128 alternator.

FIG. 14 shows illustrations showing shapes of trough zones when the output current peaks in FIGS. 12 and 13.

FIG. 15 is a graph showing calculations of De versus the output current in the φ139 alternator.

FIG. 16 is a graph showing a relationship between the trough diameter De and the output current when X1/X2=0.82 and Ls/Ly=1.21 in the φ139 alternator.

FIG. 17 shows illustrations showing shapes of trough zones when the output current peaks in FIGS. 15 and 16.

FIG. 18 is a graph showing calculations of X1/X2 versus output for the φ128 alternator (16-pole).

FIG. 19 is a graph showing calculations of X1/X2 versus output for the φ139 alternator (16-pole).

FIG. 20 shows illustrations showing cross-sectional shapes of the claw portions 112c.

### MODES FOR CARRYING OUT THE INVENTION

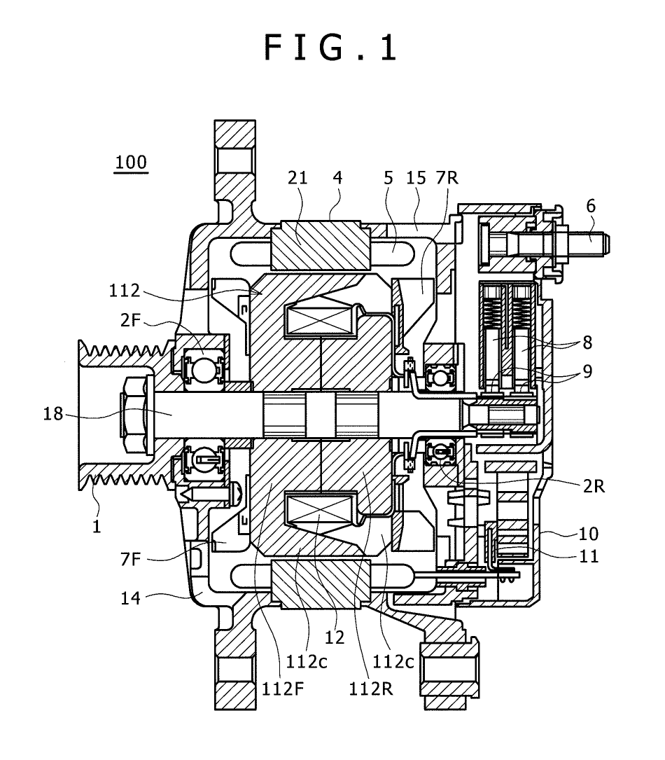

The best mode for carrying out the invention will be described below with reference to the accompanying drawings. FIG. 1 is a cross-sectional view showing arrangements of a vehicular alternating current generator 100 according to an embodiment of the present invention. A pulley 1 is mounted at a leading end of a shaft 18 on which a rotor 112 is disposed. A belt is trained over the pulley 1 and a pulley mounted on a drive shaft of an engine not shown. The shaft 18 is rotatably supported by a bearing 2F disposed in a front bracket 14 and a bearing 2R disposed in a rear bracket 15. A stator 4 faces the rotor 112 with a small gap therebetween. The stator 4 is held in position so as to be clamped between the front bracket 14 and the rear bracket 15.

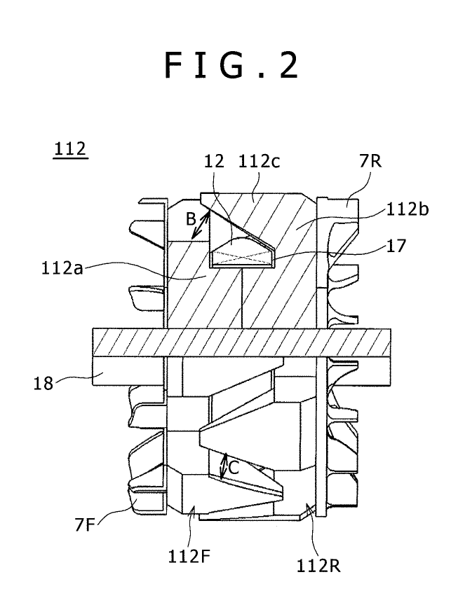

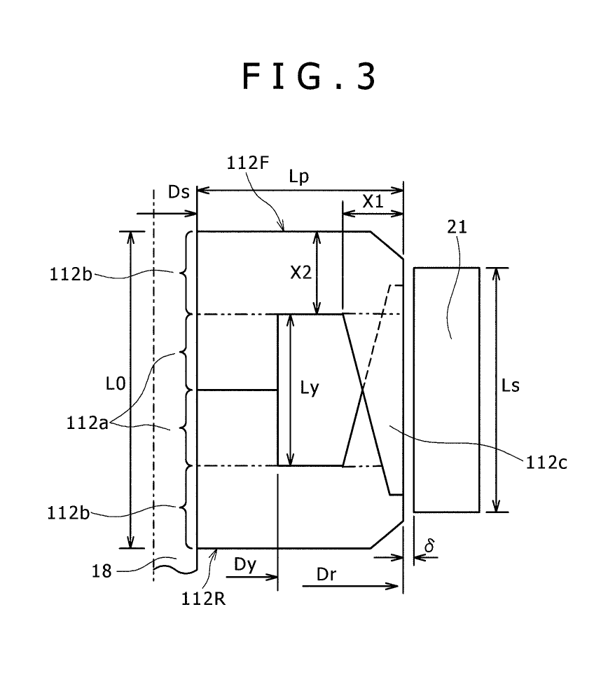

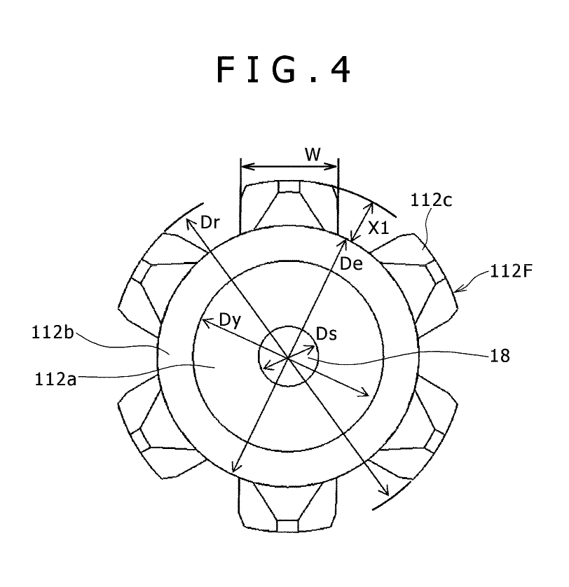

FIGS. 2, 3, and 4 illustrate the shape of the rotor 112. FIG. 2 is a general view of the rotor 112, an upper half of the rotor 112 being shown as a cross-sectional view. FIG. 3 is an illustration showing a cross section of each of a stator core 21, and a pair of rotor cores 112F, 112R that form part of the rotor 112. FIG. 4 illustrates the rotor core 112F as viewed from an axial direction. It is noted that the rotor core 112R is shaped similarly to the rotor core 112F.

The rotor 112 constitutes a Lundell rotor (a rotor having claw-shaped magnetic poles) as shown in FIG. 2. The rotor cores 112F, 112R formed from a magnetic material are connected to the shaft 18 through serration coupling at substantially central portions of the shaft 18 in a direction of a rotational axis so as to be integrally rotated with the shaft 18. Each of the rotor core 112F on the front side and the rotor core 112R on the rear side is mounted on the shaft 18 so as to have a cylindrical portion 112a facing, and abutting on, each other. Each of the rotor core 112F and the rotor core 112R has an outer end subjected to plastic flow into an annular groove formed in the shaft 18. Axial movements of the rotor cores 112F, 112R are thereby restricted.

Referring to FIGS. 3 and 4, each of the rotor cores 112F, 112R includes the cylindrical portion 112a, an end plate portion 112b extending perpendicularly to the rotational axis, and a plurality of claw portions 112c extending in parallel with the rotational axis from the end plate portion 112b. As is known from FIG. 4, the end plate portion 112b is not completely circular in shape and has portions connected to the claw portions 112c protruding in an outer peripheral direction. Each of the rotor cores 112F, 112R has six claw portions 112c, so that the rotor 112 has 12 field core poles.

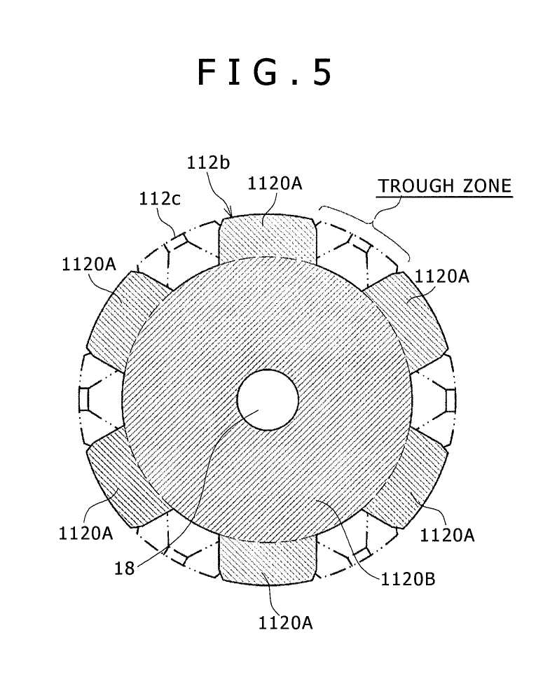

FIG. 5 shows a back side of the rotor core (the side of a surface on which the claw portions 112c are not formed). The end plate portion 112b includes a protruding zone 1120A and a disk zone 1120B. The claw portion 112c is formed in the protruding zone 1120A. The disk zone 1120B forms a circular disk. The claw portions 112c formed on the end plate portion 112b of the other rotor core are disposed at positions facing trough zones formed between each of two adjacent protruding zones 1120A as shown by a dash double-dot line.

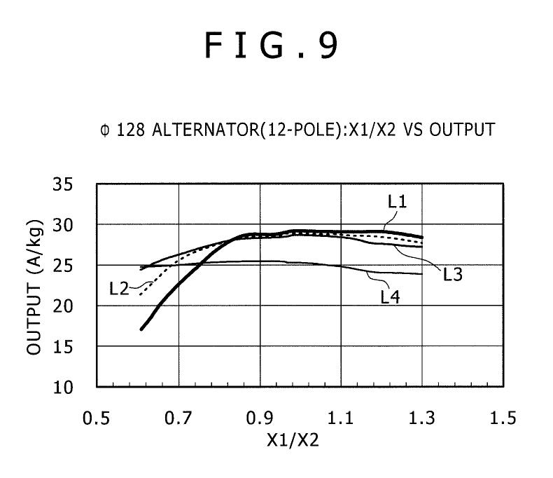

It is noted that, in the related-art vehicular alternating current generators (alternators) disclosed in Patent Documents 1 and 2, the plate-shaped yoke portion extending perpendicularly to the rotational axis forms a trough zone that represents connections between a pair of adjacent claw-shaped magnetic pole portions sharply incised on an inner peripheral side, as shown in FIG. 9 of Patent Document 1 or FIG. 3 of Patent Document 2. The trough zone has a bottom portion reaching near the cylindrical portion. In the example shown in FIG. 4, on the other hand, the trough zone between the protruding zones 1120A of the end plate portion 112b is incised only up to an inside diameter at a root of the claw portion 112c, so that the end plate portion on the side inner of the claw portion root (the shape of the disk zone 1120B of FIG. 5) is circular in shape. Though details will be described later, as compared with the sharply incised trough zones in the related art, the trough zones according to this embodiment are shallow in depth as shown in FIG. 4, which allows an output current to be improved.

Referring to FIG. 2, the rotor cores 112F, 112R are mounted on the shaft 18 such that the cylindrical portions 112a thereof face each other. The claw portion 112c disposed at the end plate portion 112b of each of the rotor cores 112F, 112R extends in the direction of the other rotor core. The claw portions 112c of the rotor core 112F and the claw portions 112c of the rotor core 112R are disposed alternately in a rotor circumferential direction.

A field coil 12 wound around a coil bobbin 17 is disposed between an outer periphery of the cylindrical portion 112a and an inner periphery of the claw portion 112c. The coil bobbin 17 is externally inserted on the cylindrical portions 112a of the rotor cores 112F, 112R, while the field coil 12 is wound around a trunk portion of the coil bobbin 17 about the rotational axis. The coil bobbin 17 is inserted between the rotor cores 112F, 112R, and the field coil 12 keeps the field coil 12 insulated.

Referring back to FIG. 1, slip rings 9 for supplying electricity to the field coil 12 are disposed at a trailing end of the shaft 18. A coil conductor constituting the field coil 12 has both ends extended along the shaft 18 and connected to the slip rings 9, respectively. Electric power for generating a magnetic field is supplied from a battery mounted on the vehicle to the field coil 12 via brushes 8 that are in contact with the slip rings 9.

A front fan 7F and a rear fan 7R each having a plurality of vanes are mounted on an outer peripheral side of the rotor 112 on front and rear end faces, respectively, in the rotational axial direction thereof. The fans 7F, 7R rotate integrally with the rotor 112 thereby to circulate air from the inner peripheral side to the outer peripheral side. It is to be noted that the front fan 7F on the side of the front bracket 14 has vanes smaller than those of the rear fan 7R on the side of the rear bracket 15. In addition, the front fan 7F has a flow rate of air to be circulated lower than that of the rear fan 7R.

The stator 4 includes the stator core 21 and a stator winding 5 and faces the rotor 112 with a small gap therebetween. The stator core 21 is held in position so as to be clamped between the front bracket 14 and the rear bracket 15. The stator winding 5 is formed as a three-phase winding, each of winding leads being connected to a rectifying circuit 11. The rectifying circuit 11 includes a rectifying element, such as a diode, and constitutes a full-wave rectifying circuit. If a diode is used, for example, the diode has a cathode terminal connected to a terminal 6 and an anode terminal connected electrically to a main unit of the vehicular alternating current generator. It is noted that a rear cover 10 having an air hole for cooling functions as a protective cover for the rectifying circuit 11.

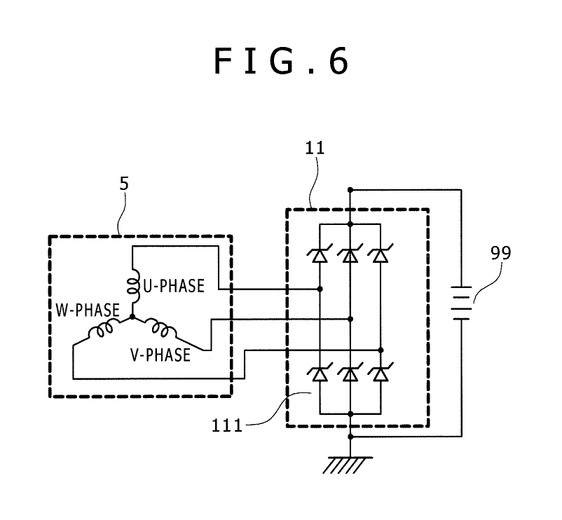

FIG. 6 illustrates an arrangement of the rectifying circuit 11 that performs three-phase full-wave rectification using six diodes 111. The rectifying circuit 11 includes three sets of series circuits connected in parallel with each other, each set including two diodes 111. U-, V-, and W-phase coils of the stator winding 5 are connected through a three-phase Y-connection. Terminals of the three-phase coils on an anti-neutral point side are connected to connecting points of the diodes 111 connected in series. Cathodes of the diodes 111 on an upper side (positive side) of the diodes ill are connected as common cathodes to a positive terminal of a battery 99. Anodes of the diodes 111 on a lower side (negative side) of the diodes 111 are connected to a negative terminal of the battery 99.

Power generating operation will be described below. As described earlier, the pulley 1 and the pulley on the engine side are connected with a belt and the rotor 112 rotates with the engine. As current flows through the field coil 12, the rotor 112 is magnetized and a magnetic path is formed in the rotor 112 as an orbital path around the field coil 12. Magnetic flux that exits the claw portion 112c of the rotor core on one side enters the stator core 21 before entering the claw portion 112c of the rotor core on the other side. Then, as the rotor 112 rotates, a rotating magnetic field is formed and a three-phase induced electromotive force develops at the stator winding 5. The voltage of the electromotive force thus generated undergoes full wave rectification at the rectifying circuit 11 mentioned earlier with a resultant DC voltage being generated. The positive side of the DC voltage is connected to the terminal 6 and further to the battery 99.

Though a detailed description is here omitted, a field current supplied to the field coil 12 is controlled such that the DC voltage resulting from the rectification is suitable for charging the battery 99. The field current is also controlled according to the condition of the battery 99 so that power generation is started when the generated voltage is higher than the vehicle battery voltage. An IC regulator (not shown) as a voltage control circuit for adjusting the generated voltage is built into the rectifying circuit 11 disposed inside the rear cover 10 shown in FIG. 1. The IC regulator controls such that a terminal voltage at the terminal 6 is constant at all times.

In this embodiment, a stator core axial length Ls shown in FIG. 3 is set to be equal to or greater than a cylindrical portion axial length Ly shown in FIG. 3. As a result, the magnetic flux generated from the cylindrical portion 112a by AT of the field coil is branched into one flowing directly into the stator core 21 via the end plate portion 112b and one flowing into the stator core 21 via the claw portion 112c. A high output as expected can be achieved, only if allocation is adequately selected between an amount of magnetic flux directly flowing into the stator core 21 and an amount of magnetic flux flowing into the stator core 21 from a claw portion outer peripheral surface by way of the claw portion 112c.

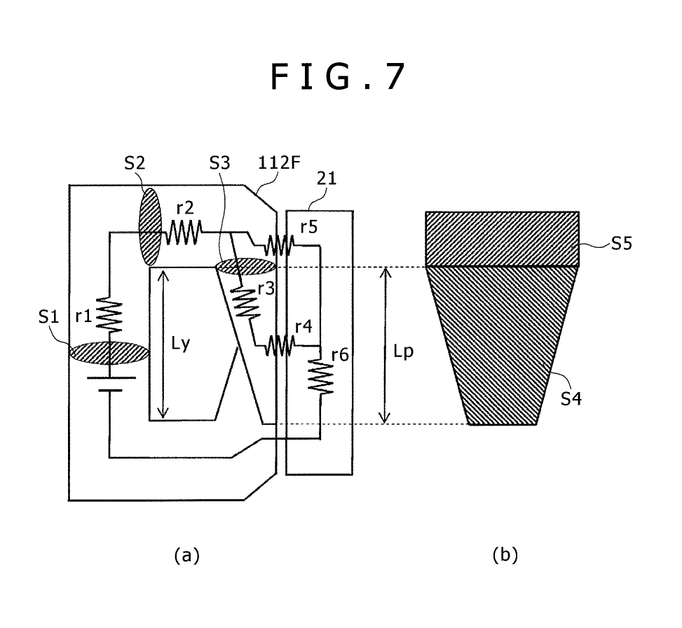

A shape allowing output to be optimized when Ls≧Ly will be described below. FIG. 7(a) shows an equivalent magnetic circuit according to the embodiment. FIG. 7(b) shows a surface of the rotor core 112F that faces the stator core 21. Referring to FIG. 7(a), S1 denotes a cross-sectional area of a magnetic path in the cylindrical portion 112a; S2 denotes across-sectional area of a magnetic path in the end plate portion 112b; and S3 denotes a cross-sectional area of a magnetic path in the claw portion 112c. Additionally, let r1 be magnetic resistance of the cylindrical portion 112a, r2 be magnetic resistance of the end plate portion 112b, and r3 be magnetic resistance of the claw portion 112c.

Referring to FIG. 7(b), reference numeral S4 denotes a surface (outer peripheral surface) of the claw portion 112c that faces the stator core 21 and also an area of that zone. Of an outer peripheral surface of the end plate portion 112b, reference numeral S5 denotes a zone that faces the stator core 21 and also an area of that zone. Let r4 be magnetic resistance of an air gap between the surface S4 of the claw portion 112c and the stator core 21. Let r5 be magnetic resistance of an air gap between the outer peripheral surface S5 of the end plate portion 112b and the stator core 21.

As is known from FIG. 7, and FIG. 5 of Patent Document 1, the magnetic flux that passes through the surfaces S3 and S4 and enters the stator core is that which passes through the magnetic resistance r3, r4. The magnetic flux that passes through the surface S5 and enters the stator core is that which passes through the magnetic resistance r5.

Referring to FIG. 3, let Dy be the outside diameter of the cylindrical portion 112a, Ds be the outside diameter of the shaft 18, and P be the field core number of poles. Then, the cross-sectional area S1 in the cylindrical portion 112a is expressed by expression (1) given below. It is noted that, since the shaft 18 is formed of a material for which emphasis is placed on mechanical strength and not on magnetic characteristic as compared with the rotor core, the shaft 18 is excluded from the magnetic circuit.

S1={π/(4·P/2)}·(Dy²−Ds²) (1)

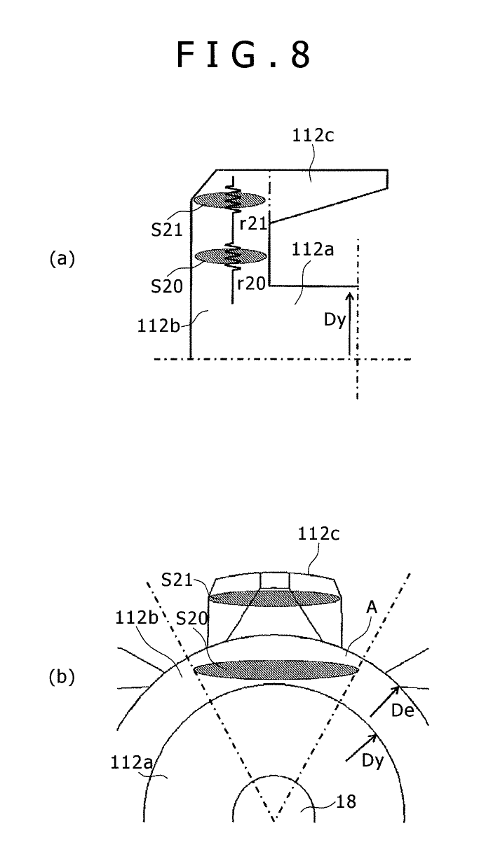

A magnetic pole width W of the claw portion 112c shown in FIG. 4 is an outer peripheral dimension π·Dr of the rotor core 112F, 112R divided by the number of poles P. Specifically, W=(π·Dr)/P. FIG. 8 illustrates details of the end plate portion 112b. A zone between the dash-single-dot lines in FIG. 8(b) is considered in association with the magnetic path for a single claw portion 112c. A zone of the end plate portion 112b from the cylindrical portion 112a to the claw portion 112c is here divided into a portion connecting to the root of the claw portion 112c and a portion denoted A between the connecting portion and the cylindrical portion 112a. S20 denotes the cross-sectional area of the portion A and r20 denotes the magnetic resistance of the portion A. Additionally, S21 denotes the cross-sectional area of the connecting portion and r21 denotes the magnetic resistance of the connecting portion.

In this case, the cross-sectional area S20 and the magnetic resistance r20 of the portion A are expressed in a simplified fashion by expressions (2) and (3) given below, where P denotes the number of poles and μ₂ denotes the permeability of the end plate portion 112b. In expression (2), the first term of the right-hand side represents an area of a circularly arcuate surface on the inner peripheral side of the portion A in FIG. 8, while the second term of the right-hand side represents an area of a circularly arcuate surface on the outer peripheral side of the portion A in FIG. 8. As a result, the cross-sectional area S20 is an average of these areas. Note that De denotes the diameter of a trough portion of a trough zone between the claw portions 112.

S20=X2·(πDy/P/2+7πDe/P/2)/2 (2)

r20=(De−Dy)/2÷(μ₂·S20) (3)

The cross-sectional area S21 and the magnetic resistance r21 of the connecting portion at the root of the claw portion are expressed in a simplified fashion by expressions (4) and (5) given below.

S21=W·X2 (4)

r21=0.5X1/(μ₂·S21) (5)

In this embodiment, therefore, the cross-sectional area S20 and the cross-sectional area S21 mentioned above are used in place of the cross-sectional area S2 shown in FIG. 7(a) to express the magnetic resistance r2 of FIG. 7(a) by expression (6) given below. On the foregoing assumption, X1 and X2 are determined so as to achieve a maximum output.

r2=r20+r21 (6)

The magnetic resistance r1 of the cylindrical portion 112a, the magnetic resistance r2 of the end plate portion 112b, and the magnetic resistance r3 of the claw portion 112c are expressed by expressions of r1=Ly/(μ₁·S1), r2=r20+r21, and r3=Lp/(μ₃·S3·k), respectively. Where, Ly denotes the axial length of the cylindrical portion 112a and Lp denotes the axial length of the claw portion 112c. Additionally, μ₁ denotes the permeability of the cylindrical portion 112a. Similarly, μ₂ denotes the permeability of the end plate portion 112b and μ₃ denotes the permeability of the claw portion 112c. k denotes a shape coefficient of the claw portion 112c, indicating that the claw portion 112c is tapered in its leading end direction. The shape coefficient empirically ranges between 1.0 and 1.3. Values of the magnetic resistance of the air gaps r4, r5 are expressed by expressions of r4=δ/(μ₀·S4) and r5=δ/(μ₀·S5), respectively, where δ denotes the dimension of the air gap.

A value of combined magnetic resistance r345 of the magnetic circuits from the end plate portion 112b to the stator core 21 is expressed by expression (7) given below using the magnetic resistance r3, r4, r5 (see FIG. 7). Let r6 be magnetic resistance of the stator core 21, then a sum of the magnetic resistance of the magnetic circuits energized by the field coil 12 is expressed by r1+r2+r345+r6. Consequently, a high output can be achieved by optimizing the combined magnetic resistance r345.

1/r345=1/(r3+r4+1/r5

r345=r5(r3+r4/(r3+r4+r5) (7)

The combined magnetic resistance r345 is expressed by expression (8) given below by substituting the expression of magnetic resistance using the cross-sectional area for each magnetic resistance of expression (7). It is noted that, in expression (8), μ_{f}=(μ₃/μ₀)·k.

r345=(LpδS4+μ_{f}δ²S3)μ₀(μ_{f}S3S4δ+S4S5Lp+μ_{f}S3S5δ) (8)

However, indeed expression (8) is convenient for explaining a phenomenon, but it is difficult to find an accurate solution by using expression (8) in an actual Lundell rotor. This is because of the following reason. The circuit is considered substantially to be a lumped circuit on the assumption that the magnetic flux density and the permeability of each block defined by each cross-sectional area and length of each of S1 to S5 remain constant. This approach produces a difference from the phenomenon exhibited by the actual Lundell rotor having a three-dimensional structure. Since iron has a magnetic saturation characteristic, the actual phenomenon is such that the permeability and the magnetic flux density are different from one micro block to another in a distributed constant manner.

Thus, for the accurate analysis of the phenomenon, a late need is toward consideration of the stator, Lundell rotor and shaft, stator coil, and flux leakage by using the three-dimensional electromagnetic field analysis technique. A method is employed for making an analysis in a distributed constant manner, in which the generator including an air layer surrounding the stator and the Lundell rotor is divided into micro blocks, each having an adequate size, in consideration of the magnetic flux distribution and density of each of different parts (analytically called a micro space block composed of nodes and elements; one unit of the vehicular alternating current generator (alternator) is divided into hundreds of thousands of blocks) and the degree of magnetic saturation, permeability, and magnetic flux density are calculated for each micro block.

To solve the foregoing problem, the three-dimensional electromagnetic field analysis considering the magnetic saturation of each magnetic circuit is applied to this embodiment. In general, alternators are divided into two series, commonly called a φ128 alternator and a φ139 alternator, with a few exceptions.

The method is first examined using the φ128 alternator. The rotor core has the shape as described above and expressions (9), (10), and (11) given below are to be satisfied. Design constants of a conventionally manufactured φ128 alternator are used for specific dimensions that are: the number of poles=12; Dy=54 mm; Ds=17 mm; Dr=99.4 mm; and δ=0.3 mm. The thickness X2 of the end plate portion 112b is X2=13.5 mm as in the conventional alternator. Additionally, Ly=26 mm and Ls is varied so that Ls/Ly=1.15 to 1.75. Ly and X2 are not varied because the current examination is to find conditions for achieving the maximum output with the same axial length and the maximum value for the φ128 alternator is selected to match the specifications set by an auto maker.

S1={π/(4·P/2)}·(Dy²−Ds²) (9)

X2=S1/W (10)

W=(π·Dr)/P (11)

[Changes in Output Current when X1/X2 is Varied]

Given these constants, let X1 be a root thickness of the claw portion 112c. Then, changes in the output current are found by changing X1/X2 from 0.6 to 1.2 and Ls/Ly from 1.15 to 1.75. It is noted that, though the combined magnetic resistance r345 is expressed using the cross-sectional areas S3, S4, and S5 in expression (4), this case uses what is rewritten using, for example, X1 and X2. Additionally, in the example shown in FIG. 4, a diameter Dc on the inner peripheral side of the root (hereinafter referred to as a claw portion root inside diameter) and the trough diameter De are identical with each other. Thus, changing X1/X2 (specifically, changing X1) will vary the trough diameter De (=Dc) accordingly.

This is to examine how the output current changes as affected by a relative relationship between X1 and X2 (specifically, S2 and S3) and the output current tends to depend on X1/X2. The output current exhibits a similar tendency when X1/X2 is varied from 0.6 to 1.2 by changing X1 with X2 fixed to 13.5 mm and, in contrast, when X1/X2 is varied from 0.6 to 1.2 by changing X2 with X1 fixed as described above.

In general, with alternators, the output current at 1800 r/min serves as a reference for evaluation. The output current here represents that with a maximum field current at a speed of 1800 r/min. If the root portion dimension X1 of the claw portion 112c is small, an increased area results over which the field coil can be wound. Thus, calculation is performed by operatively associating the dimension X1, an area over which the field coil can be wound relative to the cylindrical portion 112a (specifically, a cross-sectional area of a portion surrounded by the cylindrical portion 112a, the end plate portion 112b, and the claw portion 112c in FIG. 3), and the number of turns of the field coil (AT of the field coil) with each other. The stator core shape and the like are constant regardless of X1.

FIG. 9 shows results of simulation regarding the φ128 alternator, data L1 showing results when Ls/Ly=1.15, data L2 showing results when Ls/Ly=1.3, data L3 showing results when Ls/Ly=1.5, and data L4 showing results when Ls/Ly=1.75, respectively. The output current (A) per weight (kg) is the output (A/kg).

Tendencies of changes of data L1 to L3 are as follows. Specifically, the output increases with an increase in X1/X2 when X1/X2 falls between 0.6 and 0.8 and is substantially a maximum when X1/X2=0.9. When X1/X2 falls between 0.9 and 1.1, the output remains substantially constant even with an increase in X1/X2. When X1/X2 exceeds 1.1, L2 and L3 start decreasing and L1 starts decreasing with a point near 1.2. This suggests that, preferably, X1/X2 is set between 0.9 and 1.1 both inclusive.

The data L4 for X1/X2=1.75 exhibits a tendency of outputs different from those of the data L1 to L3. The output remains substantially constant when X1/X2 falls between 0.6 and 1.0 and decreases at a slow pace when X1/X2 is greater than 1.0. The output values are small values widely apart from the data L1 to L3 when X1/X2 is 0.8 or more. This suggests that, preferably, Ls/Ly is substantially set to be equal to, or lower than, 1.5.

The decrease in outputs when X1/X2 is smaller than 0.8 indicates that consumption of AT at the claw portion 112c increases considerably even with the increase in the number of turns of the field coil resulting from a smaller X1, so that the magnetic flux does not increase as expected relative to the increase in the number of turns of the field coil, actually the magnetic flux are decreasing. In addition, when X1/X2 falls between 0.8 and 1.1, the output remains substantially constant because of an increase and a decrease in the magnetomotive force in the claw portion 112c as a result of a change in X1/X2, and a decrease in the magnetomotive force as a result of an enlarged magnetic path cross-sectional area of the end plate portion resulting from the reduced trough zone between magnetic poles and a decrease in the number of turns of the field coil. Additionally, when X1/X2 is greater than 1.1, negative effect from the decrease in the number of turns of the field coil is slightly more than a positive effect from the decrease in the magnetic resistance, so that the output increases with the increase in X1/X2.

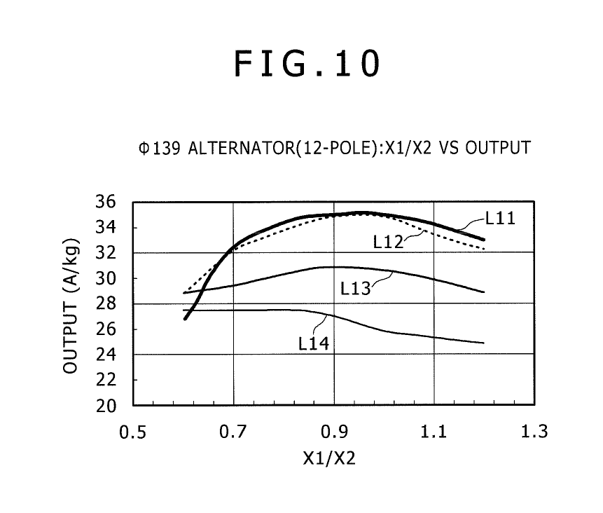

FIG. 10 shows results of simulation regarding the φ139 alternator, data L11 showing results when Ls/Ly=1.07, data L12 showing results when Ls/Ly=1.21, data L13 showing results when Ls/Ly=1.5, and data L14 showing results when Ls/Ly=1.75, respectively. With the φ139 alternator, too, design constants of a conventionally manufactured φ139 alternator are used for specific dimensions shown in FIG. 3. The dimensions are: Dy=60 mm; Ds=17 mm; Dr=106.3 mm; and δ=0.35 mm. The thickness X2 of the end plate portion 112b is X2=14.5 mm.

Calculations shown on FIG. 10 indicate that the data L11 to L13 exhibit similar tendencies of changes, while the data L14 for Ls/Ly=1.75 exhibits a tendency different from those of the data L11 to L13. This suggests that, with the φ139 alternator, too, preferably Ls/Ly is substantially set to be equal to, or lower than, 1.5.

An examination of the data L=13 for Ls/Ly=1.5 shows that an output (A/kg) peak is reached substantially at X1/X2=0.9. FIG. 10 shows that, assuming that a range of 30 (A/kg) or more is a peak range, X1/X2 in the peak range falls between 0.8 and 1.1 both inclusive. When Ls/Ly is smaller than 1.5, it is known that the output curve moves upwardly as with the data L11 and L12. As described earlier, considering that Ls/Ly is set to be 1.5 or lower, a high performance alternator can be achieved by setting X1/X2 between 0.8 and 1.1 both inclusive.

It is noted that, in the above-described simulation, the field coil 12 has a predetermined lamination factor of 68% in a space defined by inner peripheral surfaces of the cylindrical portion 112a, the end plate portion 112b, and the claw portion 112c. The number of turns is determined by adjusting the winding diameter such that the field coil resistance value is about 2 ohms in order to protect a control unit.

### [Effect of Trough Zone of End Plate Portion 112b on Output Current]

In the above-described simulation, the end plate portion 112b is shaped such that, as shown in FIG. 4 or FIG. 8, its portion on the inner peripheral side of the claw portion root is circular, while its portion connecting to the claw portion root only protrudes in the outer peripheral direction. Specifically, the above simulation results represent a case in which the diameter De of the trough portion of the trough zone between the claw portions 112c and the claw portion root diameter are set to be equal to each other.

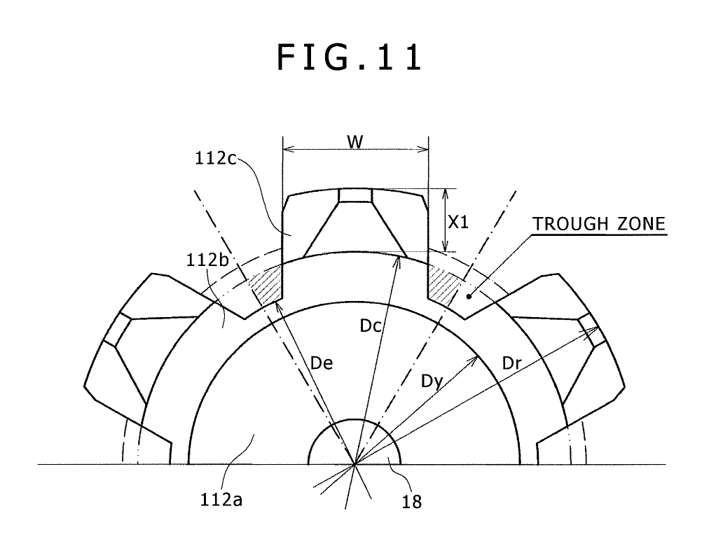

As shown in expressions (2) to (6), the magnetic resistance r2 of the end plate portion 112b varies according to the trough diameter De of the trough zone between the claw portions 112c. FIG. 11 illustrates a rotor core when the trough diameter De of the trough zone is smaller than the root inside diameter Dc of the claw portion 112c. It is noted that the rotor core shown in FIG. 4 or FIG. 8 represents that when De=Dc as indicated by the trough bottom surface shown by the dash-double-dot line in FIG. 11.

For Dc>De as shown in FIG. 11, the magnetic resistance r21 expressed by expression (12) given below needs to be used instead of expression (5) described earlier.

r21=0.5(Dr−De)/(μ₂·S21) (12)

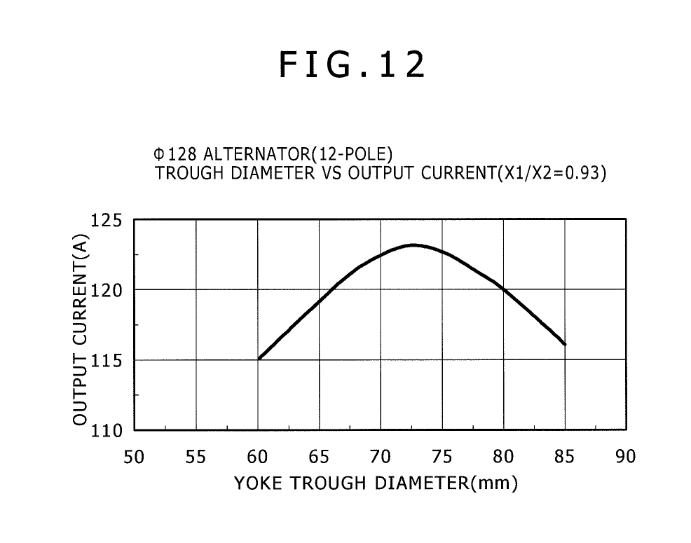

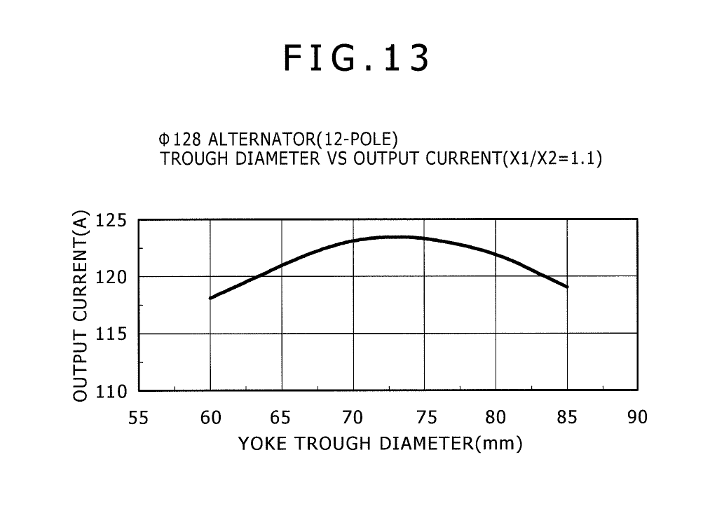

FIGS. 12 and 13 show calculations for the φ128 alternator, showing a relationship between the trough diameter De and the output current. FIG. 12 shows a case in which X1/X2=0.93, while FIG. 13 shows a case in which X1/X2=1.1. In either case, the calculation is based on Ls/Ly=1.30. Since the design constants for the φ128 alternator are set such that Dr=99.4 mm and X2=13.5 mm as described earlier, the root inside diameter Dc of the claw portion 112c for X1/X2=0.93 is Dc=74 mm and for X1/X2=1.1 is Dc=70 mm.

For both FIG. 12 and FIG. 13, the output current increases when the trough diameter De is made large to thereby reduce the size of the trough zone. This is considered to be the following reason. Specifically, filling the trough zone allows the magnetic flux to pass through the filled portion, which reduces the magnetic resistance, so that the output current is increased. The output current increases with the increase in the trough diameter De. The output current peaks at a point near De 73 mm in both FIG. 12 and FIG. 13, following a declining trend thereafter.

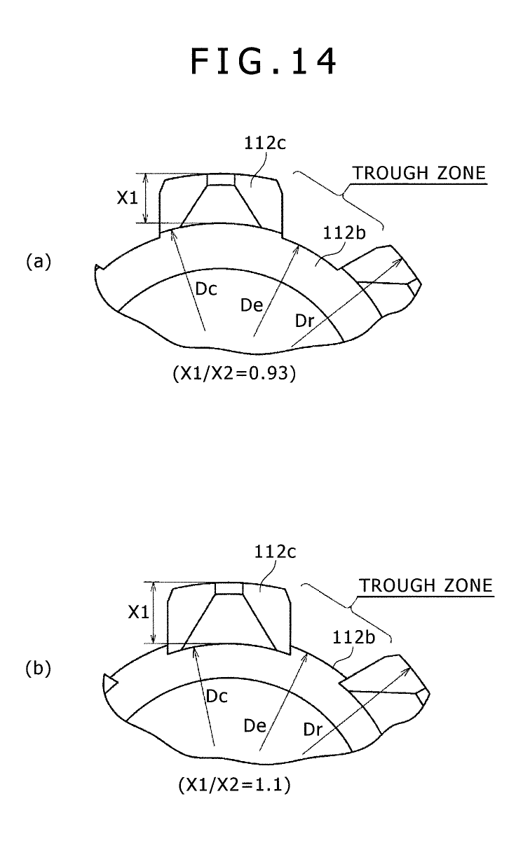

FIG. 14 shows shapes of trough zones when the output current peaks in FIGS. 12 and 13. FIG. 14(a) shows a case for FIG. 12 (X1/X2=0.93) and FIG. 14(b) shows a case for FIG. 13 (X1/X2=1.1). Referring to FIG. 14(b), for X1/X2=1.1, the trough diameter De at the peak position is greater than the claw portion root inside diameter Dc. This can also be understood from the foregoing description that the output current is improved by the magnetic flux passing through the portion of the trough zone filled in.

Similarly, for X1/X2=0.93 shown in FIGS. 12 and 14(a), too, the output current in the zone of De>Dc in FIG. 12 is expected to be greater than the output current in the zone of De=Dc. Calculations are not, however, obtained as such. This is because of the following reason. Specifically, as is known from FIGS. 2 and 5, this is affected by flux leakage through a space between the bottom portion of the trough zone (trough diameter De) and the claw portion 112c extended from the end plate portion 112b on the opposite side. The output current decreases with an increasing amount of flux leakage.

If the trough diameter De is made excessively large, excessively small a distance results between the bottom portion of the trough zone and the claw portion inner peripheral surface on the opposite side. Then, a negative effect on the output current from the flux leakage cancels a positive effect from filling the trough zone. As a result, the output current reverses the upward trend of increasing with the increase in the trough diameter De.

Assume that there is a sufficient distance available between the end plate portion 112b at which the trough zone is formed and the claw portion 112c on the opposite side. Then, even if the trough diameter De becomes larger than the claw portion root inside diameter Dc, the output current increases with the increase in the trough diameter De until a magnetic resistance reduction effect is saturated. The trough diameter De is Dr at its maximum and the trough diameter De may be Dr or less when the output current peaks.

In reality, however, as the trough diameter De increases, the output current starts decreasing after about De=73 mm as shown in FIGS. 12 and 13, as affected by the flux leakage through the space relative to the claw portion 112c on the opposite side. A dimension of a gap between claw magnetic poles may serve as a guide for the trough diameter De at which an effect from the flux leakage starts to develop. To set the trough diameter De of the trough zone such that a large output current can be achieved, not only the reduction in the magnetic resistance but also the flux leakage described above needs to be taken into consideration. Consequently, the trough diameter De is, preferably, set such that a distance B between the claw portion 112c and the trough bottom portion shown in FIG. 2 is equal to, or more than, a distance C between the claw portions 112c.

Referring to FIGS. 12 and 13, changes in the output current when the trough diameter De is varied exhibit similar tendencies without being dependent on the X1/X2 values. In FIG. 12, by setting the trough diameter De of the trough zone to fall between 68 mm and 78 mm both inclusive, an output current up to a range of about 2 (A) lower than the maximum output current can be obtained. In FIG. 13, if the range of the trough diameter De is set in a similar manner, reduction from the maximum output current is 1 (A) or lower. Consequently, for the φ128 alternator, to obtain an output current in the range of up to near the maximum output current minus 2 (A), the trough diameter De is, preferably, set to fall between 68 mm and 78 mm both inclusive.

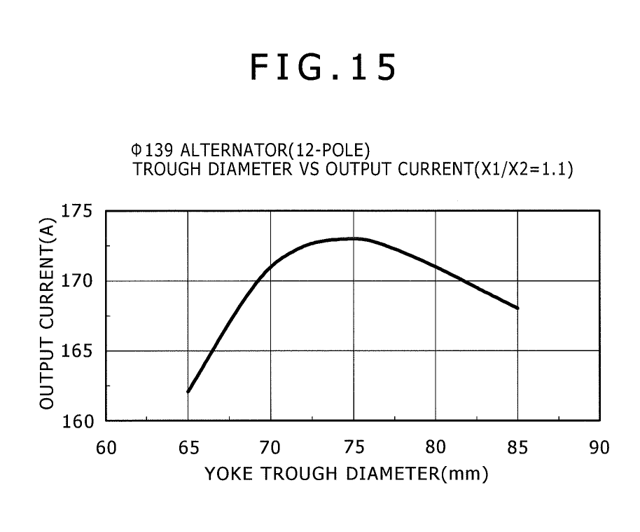

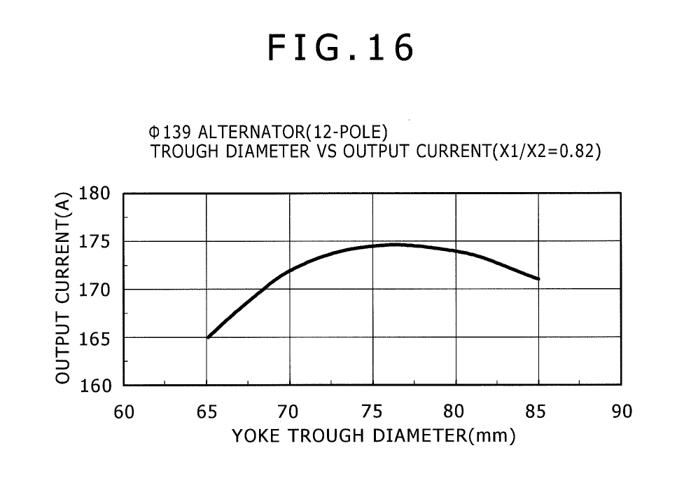

FIGS. 15 and 16 show calculations for the φ139 alternator. FIG. 15 shows a case in which X1/X2=1.1, while FIG. 13 shows a case in which X1/X2=0.82. In either case, the calculation is based on Ls/Ly=1.21. Since the design constants for the φ139 alternator are set such that Dr=106.3 mm and X2=14.5 mm, the claw portion root inside diameter Dc for X1/X2=1.1 is Dc=74 mm and for X1/X2=0.82 is Dc=83 mm.

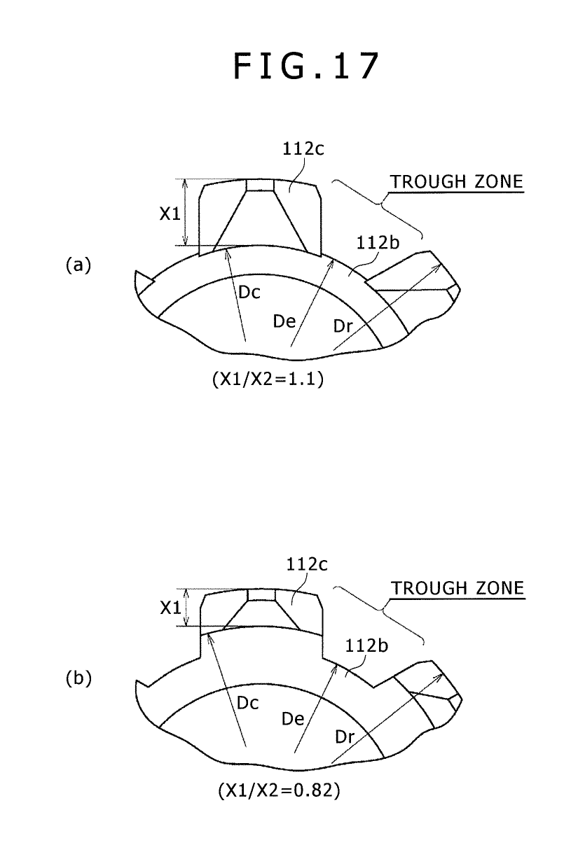

The output currents shown in FIGS. 15 and 16 exhibit similar tendencies and have peak points close to each other. For X1/X2=1.1 shown in FIG. 15, the peak point is close to De=75, while for X1/X2=0.82 shown in FIG. 16, the peak point is close to De=77. FIG. 17 shows shapes of trough zones when the output current peaks in FIGS. 15 and 16. FIG. 17(a) shows a case for FIG. 15 (X1/X2=1.1) and FIG. 17(b) shows a case for FIG. 16 (X1/X2=0.82).

With the φ139 alternator, too, the effect from the flux leakage through the space between the bottom portion of the trough zone and the claw portion 112c on the opposite side develops. With the case of FIG. 16, in particular, the trough diameter De at the peak point is relatively large relative to the claw portion root inside diameter Dc. Even if the claw portion root inside diameters Dc differ with different X1/X2 values as above, the peak points are similar to each other and the curves take similar shapes as shown in FIGS. 15 and 16.

In FIG. 15, by setting the trough diameter De of the trough zone to fall between 70 mm and 80 mm both inclusive, an output current up to a range of about 2 (A) lower than the maximum output current can be obtained. In FIG. 16, the range of the trough diameter De over which the output current of up to about 2 (A) lower than the maximum output current can be obtained falls substantially between 70 mm and 83 mm both inclusive. Consequently, for the φ139 alternator, to obtain an output current in the range of up to near the maximum output current minus 2 (A), the trough diameter De is, preferably, set to fall between 70 mm and 80 mm both inclusive.

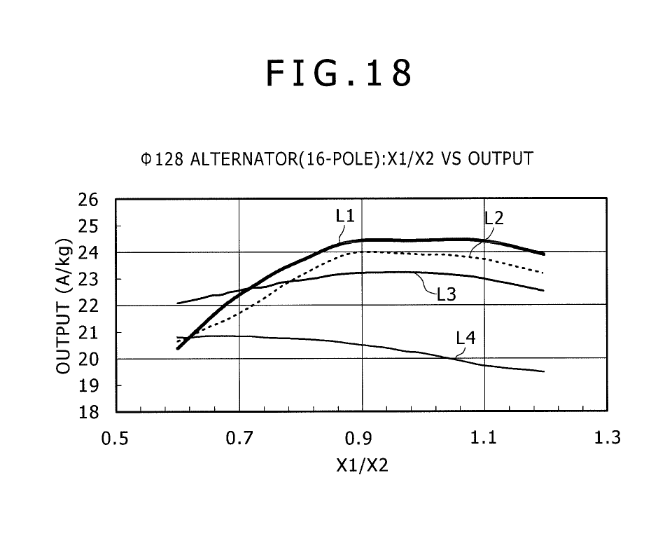

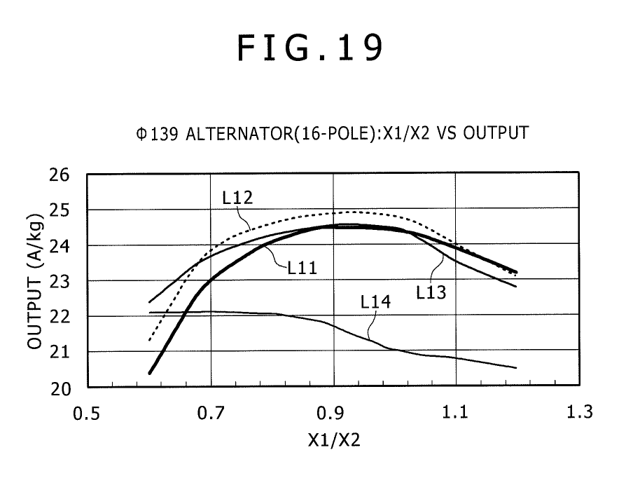

In general, known rotors incorporated in alternators have either 12 poles or 16 poles. FIGS. 18 and 19 show calculations of the output current relative to X1/X2 for the 16-pole configuration. FIG. 18 shows calculations for the φ128 alternator, while FIG. 19 shows those for the φ139 alternator. FIGS. 18 and 19 correspond to FIGS. 9 and 10 that are concerned with a 12-pole configuration, exhibiting similar tendencies. As with the 12-pole configuration, the range of X1/X2 to achieve a substantially maximum output current can be said to fall between 0.9 and 1.1 for the φ128 alternator and between 0.8 and 1.1 for the φ139 alternator. As such, the 12-pole configuration and the 16-pole configuration exhibit similar output tendencies.

### [Description Pertaining to Coil Cooling]

As shown in FIG. 2, the rotor 112 includes the front fan 7F and the rear fan 7R and the field coil 12 is cooled by cooling air created by the fans 7F, 7R. If the trough diameter De is set such that De>Dc as shown in FIG. 14(b), therefore, a coil outside diameter Dcoil is smaller than the trough diameter De even with the field coil 12 wound up to the claw portion root inside diameter Dc. As a result, the end plate portion 112b blocks flow of the cooling air to the outer peripheral surface of the field coil 12, thus reducing a coil cooling effect.

Considering also the cooling of the field coil 12, therefore, preferably the trough diameter De is set such that De≦Dcoil. Consider, for example, a case in which the trough diameter De at the peak point of the output current is such that De>Dc as shown in FIGS. 14(b) and 17(a). If the field coil 12 is wound up to the claw portion root inside diameter Dc, De is set to be Dc (=Dcoil). If the coil outside diameter Dcoil is smaller than Dc (Dcoil<Dc), De is then set to be Dcoil. Consider another case in which the trough diameter De at the peak point of the output current is such that De<Dc as shown in FIGS. 14(a) and 17(b). If the field coil 12 is wound up to the claw portion root inside diameter Dc, the trough diameter De can be set to that at the peak point. Understandably, De may be set to be Dcoil, if the trough diameter at the peak point De(peak) is smaller than the coil outside diameter Dcoil (Dcoil<De(peak)).

It is noted that the field coil 12 wound around the cylindrical portion 112a may bulge in the outer peripheral direction at its axial central portion. Nonetheless, the coil outside diameter Ccoil is here considered as the outside diameter on either end in the axial direction.

### [Description Pertaining to Claw Cross-Sectional Shape]

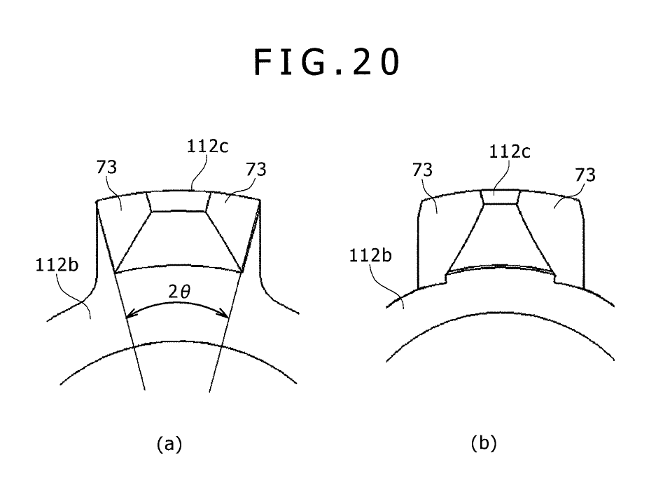

Referring to FIG. 20(a), in the conventional Lundell rotor, each of the claw portions 112c has two side surfaces 73, each facing the adjacent claw portion 112c. Each of these side surfaces 73 is tapered from the outside diameter side toward the inside diameter side. Each side surface 73 is tapered at an angle of θ, so that the two side surfaces 73 form an angle of 2θ. For the 12-pole configuration, for example, the side surface 73 on one side of one claw portion 112c is tapered 15 degrees. With the 16-pole configuration, the side surface 73 on one side of one claw portion 112c is tapered 11.25 degrees.

The foregoing shape arrangement is intended to keep constant from the outside diameter side toward the inside diameter side the dimension of a gap between adjacent claw portions of the rotor 112, specifically, the dimension of a gap between the claw portion 112c of the rotor core 112F and the claw portion 112c of the rotor core 112R. With an intention to prevent flux leakage from the space between the claw portions 112c from increasing, the arrangement ensures that the gap between the claw portions 112c does not become smaller toward the inside diameter side.

As shown in FIG. 20(b), however, an electromagnetic field analysis made by the inventor revealed that eliminating the tapering (e.g. 15 degrees on one side for the 12-pole configuration) toward the inside diameter side thereby to have an identical dimension on the outside diameter side and the inside diameter side and having a larger cross section for the claw portion 112c was more effective in increasing the output current. Actual calculations show that having the same width dimension of the claw portion 112c for the inside diameter and the outside diameter improves the output by about 10% over the tapered arrangement.

As described heretofore, the vehicular alternating current generator according to the present invention comprises the Lundell rotor 112 and the stator 4. The Lundell rotor 112 includes: the cylindrical portion 112a around which the field coil 12 is wound; the plate-shaped first and second end plate portions 112b disposed on both end faces in the axial direction of the cylindrical portion 112a so as to face each other; the first claw portions 112c extending in parallel with the rotational axis in a direction from the first end plate portion 112b to the second end plate portion; and the second claw portions 112c extending in parallel with the rotational axis in a direction from the second end plate portion 112b to the first end plate portion and disposed circumferentially and alternately relative to the first claw portions 112c. The stator is disposed on the outer periphery of the Lundell rotor 112 so as to face the Lundell rotor 112 with a small rotational air gap therebetween and has a laminated core around which the armature coil 5 is wound. Each of the first and second end plate portions 112b includes the disk zone 1120B that is continuous around the entire circumference of the rotational axis and the protruding zones 1120A protruding in the outer peripheral direction from the disk zone 1120B thereby to form the claw portions 112c. The bottom portion of the trough zone formed between adjacent protruding zones is set to have the diameter dimension De that is equal to, or more than, the root inside diameter dimension Dc of the claw portion 112c formed on the protruding zone 1120A and that is equal to, or less than, the outside diameter dimension Dr of the claw portion 112c. This allows the magnetic resistance to be reduced and the output current to be improved.

The protruding zone 1120A on which the claw portion 112c tends to be deformed such that the claw portion 112c opens outwardly due to a centrifugal force acting thereon. In this embodiment, however, the trough zone is made smaller in size than in the related art configuration, so that the protruding zone 1120A protrudes small in the outside diameter direction for greater mechanical strength. This reduces deformation of the protruding zone 1120A that may otherwise cause the claw portion 112c to open outwardly.

Referring to FIG. 2, the cooling air generated by the fans 7F, 7R is adapted to blow against the field coil 12 from the back surface side (outside) of the end plate portion 112b. If the trough zone is sharply incised as in the related art configuration, for example, dust that flows in with the cooling air tends to deposit on the field coil through the trough zone. Since the trough zone according to this embodiment is smaller than in the related art configuration, however, deposition of, for example, dust on the field coil 12 can be reduced.

Referring to FIG. 20(b), the claw portion 112c has, in a cross section extending perpendicularly to a direction in which the claw portion 112c is extended, a circumferential width dimension equally set from the outer peripheral side to the inner peripheral side. This arrangement promotes improved output current as compared with the related art vehicular alternating current generator having a shape tapered toward the inner peripheral side as shown in FIG. 20(a).

The foregoing embodiment has been described for a two-piece configuration having the rotor 112 composed of the rotor cores 112F, 112R. Nonetheless, the present invention can be similarly applied to a three-piece rotor that includes a pair of end plates formed with claw portions and a cylindrical member disposed so as to be clamped by one of the end plates.

In the above-described embodiment, the bottom portion of the trough zone has a circularly arcuate surface. The surface may, however, be planar. In this case, the above-described trough diameter De may double a distance between the plane and the axial center.

Each of the above-described embodiments may be implemented singularly or in combination with each other, because an effect of each individual embodiment can be produced singularly or synergistically. The present invention is not specifically limited to the above embodiments as far as the effect of the present invention is not impaired.

1. A nominal φ128 vehicular alternating current generator, comprising:
a Lundell rotor including:
a cylindrical portion around which a field coil is wound;
plate-shaped first and second end plate portions disposed on both end faces in an axial direction of the cylindrical portion so as to face each other;
a plurality of first claw portions extending in parallel with a rotational axis in a direction from the first end plate portion to the second end plate portion; and
second claw portions extending in parallel with the rotational axis in a direction from the second end plate portion to the first end plate portion, the second claw portions being disposed circumferentially and alternately relative to the first claw portions; and
a stator disposed on an outer periphery of the Lundell rotor so as to face the Lundell rotor with a small rotational air gap therebetween, the stator having a laminated core around which an armature coil is wound, wherein
each of the first and second end plate portions includes a disk zone that is continuous around an entire circumference of the rotational axis and a plurality of protruding zones protruding in an outer peripheral direction from the disk zone thereby to form the claw portions; and
a bottom portion of a trough zone formed between adjacent protruding zones is set to have a diameter dimension that falls between 68 mm and 78 mm both inclusive.

2. The vehicular alternating current generator according to claim 1, wherein
let Ls be a rotational axial length of the laminated core, Ly be a length of the cylindrical portion, X2 be a thickness of the first and second end plate portions, and X1 be a root diametric thickness of the first and second claw portions, then a ratio Ls/Ly is set to be 1.0 or more and a ratio X1/X2 is set to fall between 0.9 and 1.1 both inclusive.

3. A nominal φ139 vehicular alternating current generator, comprising:
a Lundell rotor including:
a cylindrical portion around which a field coil is wound;
plate-shaped first and second end plate portions disposed on both end faces in an axial direction of the cylindrical portion so as to face each other;
a plurality of first claw portions extending in parallel with a rotational axis in a direction from the first end plate portion to the second end plate portion; and
second claw portions extending in parallel with the rotational axis in a direction from the second end plate portion to the first end plate portion, the second claw portions being disposed circumferentially and alternately relative to the first claw portions; and
a stator disposed on an outer periphery of the Lundell rotor so as to face the Lundell rotor with a small rotational air gap therebetween, the stator having a laminated core around which an armature coil is wound, wherein
each of the first and second end plate portions includes a disk zone that is continuous around an entire circumference of the rotational axis and a plurality of protruding zones protruding in an outer peripheral direction from the disk zone thereby to form the claw portions; and
a bottom portion of a trough zone formed between adjacent protruding zones is set to have a diameter dimension that falls between 70 mm and 80 mm both inclusive.

4. The vehicular alternating current generator according to claim 3, wherein
let Ls be a rotational axial length of the laminated core, Ly be a length of the cylindrical portion, X2 be a thickness of the first and second end plate portions, and X1 be a root diametric thickness of the first and second claw portions, then a ratio Ls/Ly is set to be 1.0 or more and a ratio X1/X2 is set to fall between 0.8 and 1.1 both inclusive.

5. The vehicular alternating current generator according to claim 1, wherein
the bottom portion of the trough zone formed between the adjacent protruding zones is set to have a diameter dimension that is equal to, or less than, an outside diameter of the field coil.

6. A vehicular alternating current generator, comprising:
a Lundell rotor including:
a cylindrical portion around which a field coil is wound;
plate-shaped first and second end plate portions disposed on both end faces in an axial direction of the cylindrical portion so as to face each other;
a plurality of first claw portions extending in parallel with a rotational axis in a direction from the first end plate portion to the second end plate portion; and
second claw portions extending in parallel with the rotational axis in a direction from the second end plate portion to the first end plate portion, the second claw portions being disposed circumferentially and alternately relative to the first claw portions; and
a stator disposed on an outer periphery of the Lundell rotor so as to face the Lundell rotor with a small rotational air gap therebetween, the stator having a laminated core around which an armature coil is wound, wherein
each of the first and second end plate portions includes a disk zone that is continuous around an entire circumference of the rotational axis and a plurality of protruding zones protruding in an outer peripheral direction from the disk zone thereby to form the claw portions; and
a bottom portion of a trough zone formed between adjacent protruding zones is set to have a diameter dimension that is equal to, or more than, a root inside diameter dimension of the claw portion formed on the protruding zone and equal to, or less than, an outside diameter dimension of the claw portion.

7. The vehicular alternating current generator according to claim 6, wherein
the bottom portion of the trough zone is further set to have a diameter dimension such that a dimension of a gap between the pawl portion extending from the other end plate portion and the bottom portion is equal to, or more than, a dimension of a gap between the first claw portion and the second claw portion.

8. A vehicular alternating current generator, comprising:
a Lundell rotor including:
a cylindrical portion around which a field coil is wound;
plate-shaped first and second end plate portions disposed on both end faces in an axial direction of the cylindrical portion so as to face each other;
a plurality of first claw portions extending in parallel with a rotational axis in a direction from the first end plate portion to the second end plate portion; and
second claw portions extending in parallel with the rotational axis in a direction from the second end plate portion to the first end plate portion, the second claw portions being disposed circumferentially and alternately relative to the first claw portions; and
a stator disposed on an outer periphery of the Lundell rotor so as to face the Lundell rotor with a small rotational air gap therebetween, the stator having a laminated core around which an armature coil is wound, wherein
each of the first and second end plate portions includes a disk zone that is continuous around an entire circumference of the rotational axis and a plurality of protruding zones protruding in an outer peripheral direction from the disk zone thereby to form the claw portions; and
a bottom portion of a trough zone formed between adjacent protruding zones is set to have a diameter dimension that is equal to an outside diameter of the field coil.

9. The vehicular alternating current generator according to claim 1, wherein
the first and second claw portions have, in a cross section extending perpendicularly to a direction in which the claw portions are extended, a circumferential width dimension equally set from an outer peripheral side to an inner peripheral side.

10. The vehicular alternating current generator according to claim 1, wherein
the cylindrical portion comprises a first cylindrical portion and a second cylindrical portion formed separately from each other; and
the Lundell rotor is a two-piece rotor comprising the first end plate portion, the first claw portions, and the first cylindrical portion formed integrally with each other and the second end plate portion, the second claw portions, and the second cylindrical portion formed integrally with each other.

11. The vehicular alternating current generator according to claim 1, wherein
the Lundell rotor is a three-piece rotor comprising the cylindrical portion, the first end plate portion formed with the first claw portions, and the second end plate portion formed with the second claw portions, the cylindrical portion and the first and second end plate portions being formed separately from each other.

12. The vehicular alternating current generator according to claim 2, wherein
the bottom portion of the trough zone formed between the adjacent protruding zones is set to have a diameter dimension that is equal to, or less than, an outside diameter of the field coil.

13. The vehicular alternating current generator according to claim 3, wherein
the bottom portion of the trough zone formed between the adjacent protruding zones is set to have a diameter dimension that is equal to, or less than, an outside diameter of the field coil.

14. The vehicular alternating current generator according to claim 4, wherein
the bottom portion of the trough zone formed between the adjacent protruding zones is set to have a diameter dimension that is equal to, or less than, an outside diameter of the field coil.

15. The vehicular alternating current generator according to claim 2, wherein
the first and second claw portions have, in a cross section extending perpendicularly to a direction in which the claw portions are extended, a circumferential width dimension equally set from an outer peripheral side to an inner peripheral side.

16. The vehicular alternating current generator according to claim 3, wherein
the first and second claw portions have, in a cross section extending perpendicularly to a direction in which the claw portions are extended, a circumferential width dimension equally set from an outer peripheral side to an inner peripheral side.

17. The vehicular alternating current generator according to claim 4, wherein
the first and second claw portions have, in a cross section extending perpendicularly to a direction in which the claw portions are extended, a circumferential width dimension equally set from an outer peripheral side to an inner peripheral side.

18. The vehicular alternating current generator according to claim 5, wherein
the first and second claw portions have, in a cross section extending perpendicularly to a direction in which the claw portions are extended, a circumferential width dimension equally set from an outer peripheral side to an inner peripheral side.

19. The vehicular alternating current generator according to claim 6, wherein
the first and second claw portions have, in a cross section extending perpendicularly to a direction in which the claw portions are extended, a circumferential width dimension equally set from an outer peripheral side to an inner peripheral side.

20. The vehicular alternating current generator according to claim 7, wherein
the first and second claw portions have, in a cross section extending perpendicularly to a direction in which the claw portions are extended, a circumferential width dimension equally set from an outer peripheral side to an inner peripheral side.
